(19) United States
(12) Patent Application Publication
(10) Pub. No.: US 2019/0092981 A1
(43) Pub. Date: Mar. 28, 2019

(54) Adhesive tape and flat web material comprising such tape

(71) Applicant: TESA SE, Norderstedt (DE)

(72) Inventors: Niels CZERWONATIS, Hamburg (DE); Marco WALPER, Norderstedt (DE)

(21) Appl. No.: 16/135,834

(22) Filed: Sep. 19, 2018

(30) Foreign Application Priority Data
Sep. 26, 2017 (DE) 10 2017 217 094.8

(51) Int. Cl. C09J 7/40; C09J 7/20; C09J 7/30

(52) U.S. Cl. CPC C09J 7/40; C09J 2205/31; C09J 7/30; C09J 7/20

(57) ABSTRACT

Subject matter of the invention is an adhesive tape (K) for on-the-fly roll changeover of flat web material (RB) wound up into rolls (R; B), having a carrier layer (K3), which comprises a first surface (K31) and a second surface (K32) opposite the first surface (K31), a first layer of adhesive (K1), which is disposed indirectly or directly over at least part of the area on the first surface (K31) of the carrier layer (K3), a second layer of adhesive (K2), which is disposed on at least one areal region (FB) of the second surface (K32) of the carrier layer (K3), and at least one predetermined breakage area for the areal splitting of the adhesive tape (K), where the predetermined breakage area is configured such that the at least one areal region (FB) comprises a surface coating (K4), which is disposed between the carrier layer (K3) and the second layer of adhesive (K2), where the forces of adhesion of the second layer of adhesive (K2) to the surface coating (K4) are greater than the forces of adhesion of the surface coating (K4) to the carrier layer (K3), and/or where the forces of adhesion of the second layer of adhesive (K2) to the surface coating (K4) are greater than the forces of cohesion within the surface coating (K4), wherein the second layer of adhesive (K2) has a deactivated bonding region (K6) on a surface (K21) pointing in the carrier layer (K3) direction.

The invention relates to an adhesive tape for on-the-fly roll changeover of flat web material wound up into rolls, having a carrier layer, which comprises a first surface and a second surface opposite the first surface, a first layer of adhesive, which is disposed indirectly or directly over at least part of the area on the first surface of the carrier layer, a second layer of adhesive, which is disposed on at least one areal region of the second surface of the carrier layer, and at least one predetermined breakage area for the areal splitting of the adhesive tape, where the predetermined breakage area is configured such that the at least one areal region comprises a surface coating, which is disposed between the carrier layer and the second layer of adhesive, where the forces of adhesion of the second layer of adhesive to the surface coating are greater than the forces of adhesion of the surface coating to the carrier layer, and/or where the forces of adhesion of the second layer of adhesive to the surface coating are greater than the forces of cohesion within the surface coating. The invention further relates to a flat web material which is wound up into a roll and comprises an adhesive tape of this kind. The invention relates, furthermore, to a use of an adhesive tape of this kind.

### PRIOR ART

A corresponding adhesive tape is known from DE 10 2015 214 193 A1. In paper mills or the like, on-the-fly roll changeover is a commonplace method for replacing an old, almost fully unwound roll of a flat web material by a new roll without having to halt the high-speed machinery. The adhesive tape is applied to the start region of a flat web material wound up into a roll, the adhesive tape being joined to the flat web material by adhesive bonding with its first layer of adhesive and with its second layer of adhesive. The unwinding of the flat web material from a new roll, which is intended to replace an old roll on which the flat web material is almost completely unwound is referred to as “on-the-fly roll changeover”, when it takes place with running flat web material. In this procedure, the adhesive tape joined to the flat web material of the new roll is split in the region of the predetermined breakage area in such a way that the second layer of adhesive parts from the carrier layer. In this operation, the first layer of adhesive and the carrier layer remain on a first region of the flat web material, and the second layer of adhesive and the surface coating applied to the second layer of adhesive remain on a second region, disposed at a distance from the first region, of the flat web material. The first region of the flat web material of the new roll only partly masks the first layer of adhesive. The region of the first layer of adhesive that is not masked by the flat web material of the new roll bonds to the flat web material of the old roll, whereas the second layer of adhesive bonds to the flat web material of the new roll. After splitting has taken place, the second layer of adhesive ought to be masked completely by the surface coating, in order to avoid the risk of web tearing as a result of an exposed adhesive. By means of the adhesive tape, with its two opposing layers of adhesive, it is possible to ensure that prior to a roll changeover there is no unwinding of the flat web material of the new roll, since the flat web material is held together by way of the specific construction of the adhesive tape. As soon as the new roll is to replace the old roll and the “on-the-fly roll changeover” occurs, the predetermined breakage area of the adhesive tape is intended to ensure controlled and defined opening and unwinding of the flat web material of the new roll.

### SUMMARY OF THE INVENTION: PROBLEM, SOLUTION, ADVANTAGES

The problem addressed by the present invention is that of providing an adhesive tape, and also a flat web material featuring such an adhesive tape, with which the splitting of the adhesive tape in the region of the predetermined breakage area can be further improved.

This problem is solved with the features of the independent claims. Advantageous embodiments and developments of the invention are recorded in the dependent claims.

The adhesive tape according to the invention is notable for the fact that the second layer of adhesive comprises a deactivated bonding region on a surface pointing in the carrier layer direction.

In the deactivated bonding region, the second layer of adhesive, more particularly the surface of the second layer of adhesive that is pointing in the carrier layer direction has no bonding activity. As a result, in the deactivated bonding region, the substance-to-substance bonding of the second layer of adhesive to the surface coating and/or to the carrier layer is nullified. Because of the deactivated bonding region, a kind of projection of the second layer of adhesive is achieved in the region of the predetermined breakage area. As a result of this projection, the splitting characteristics in the region of the predetermined breakage area can be improved, since the commencement or start of the splitting in the region of the predetermined breakage area can take place in a more defined and controlled way by virtue of the projection. The projection formed by the deactivated bonding region constitutes a kind of activating region for the splitting of the adhesive tape in the region of the predetermined breakage area, and so a tear can be initiated deliberately and in a defined way into the splitting plane of the predetermined breakage area. This aid to initial splitting promotes even more reliable and gentle initial splitting in the region of the predetermined breakage area, thereby having the particular effect of also reducing the probability of defective initial splitting. The formation of the deactivated bonding region can be realized by regionally deactivating or nullifying the bonding activity of the surface of the second layer of adhesive that is pointing in the carrier layer direction, before the application, in particular by lamination, of the second layer of adhesive to the surface coating and hence to the carrier layer. The surface coating may make up all of or only a partial area of the second layer of adhesive.

In order to be able to achieve particularly good initial splitting characteristics, the deactivated bonding region is preferably disposed adjacently to an edge region of the second layer of adhesive, said edge region extending in the longitudinal direction of the adhesive tape.

The second layer of adhesive is preferably disposed at a distance from an edge region of the carrier layer, said edge region extending in the longitudinal direction of the adhesive tape. This distance forms a kind of recessing of the second layer of adhesive relative to the edge region of the carrier layer. Accordingly, the second layer of adhesive does not finish flush, preferably, with the edge region of the carrier layer, but is instead disposed at a distance from the edge region of the carrier layer. The distance A may preferably be 0.5 mm≤A≤5 mm, more preferably 1 mm≤A≤3 mm. Because of the distance between the second layer of adhesive and the carrier layer edge region extending in the longitudinal direction of the adhesive tape, further improvement is possible in the splitting characteristics, especially the initial splitting, of the predetermined breakage area. The distance or the recessing allows a reduction in a required peak in force during the initial splitting. To overcome the splitting resistance at the leading edge, an increased, maximum force is needed for initially splitting the system (initial splitting force for initiating the splitting process of the predetermined breakage site). Furthermore, a force at a lower level is required for splitting over the entire width of the splicing tape (split continuation force). The product of the force expended and the width of the splitting system is the energy needed for splitting (splitting energy). The initial splitting force ought to be set at a level such that the product does not open prematurely as a result of the aerodynamic forces and centrifugal forces which act during the acceleration; on the other hand, the splitting energy must be set at a level low enough for no tears to result from the energy required for the complete splitting-through of the predetermined breakage area. Outstanding values for these parameters can be realized by means of the design of the adhesive tapes of the invention.

In order to be able to achieve uniform splitting characteristics of the predetermined breakage area over the entire length of the predetermined breakage area, the deactivated bonding region preferably extends over the entire length of the second layer of adhesive. Alternatively, however, it is also possible for the deactivated bonding region to extend in sections and therefore only over part of the area of the length of the second layer of adhesive. The length of the predetermined breakage area and the length of the layer of adhesive extend in the longitudinal direction of the adhesive tape.

The deactivated bonding region preferably extends over a sub-region of the total width of the second layer of adhesive. The deactivated bonding region here preferably has a width b_{dK} which is less than half the total width bs of the second layer of adhesive. In this way, in spite of improved splitting characteristics of the predetermined breakage area, it is still possible to ensure sufficiently good bonding activity on the part of the second layer of adhesive with respect to the surface coating and/or to the carrier layer, in order to be able reliably to prevent unwinding of the flat web material before the splitting process at the predetermined breakage area.

The deactivated bonding region may have a width of 0.5 mm≤b_{dK}≤5 mm, preferably of 1 mm≤b_{dK}≤3 mm. More preferably the deactivated bonding region has a width of 1.5 mm≤b_{dK}≤2.5 mm.

There are various possible ways of forming the deactivated bonding region on the surface of the second layer of adhesive that points in the predetermined breakage area direction.

For example, the deactivated bonding region may be formed by application of an ink or a varnish to the surface of the second layer of adhesive that points in the carrier layer direction. These inks or varnishes may for example be those known as UV varnishes or UV inks. However, it is also possible to employ other crosslinking or drying—for example air-drying—inks or varnishes. The curing of the ink or varnish produces a permanent barrier layer, thereby enabling the bonding region to be deactivated. The ink or the varnish may be applied, for example, by a printing process, as for example by means of a printing mechanism or inkjet. Furthermore, the ink or the varnish may also be coated on, by means for example of pens arranged in a mount. In this case, particularly low thickness in the pm range can be achieved. Deactivation in a sub-region is also possible. Any other application processes may likewise be used.

Further, the deactivated bonding region may be formed by applying a web-like, non-adhesive strip of material to the surface of the second layer of adhesive that points in the carrier layer direction. The strip of material may be formed, for example, from a plastics material or else from a metal material. For example, the strip of material may be a foil strip, such as an aluminium foil or a PET foil, for example. The thickness of the strip of material ought to be as low as possible. For example, the strip of material may have a thickness of around 2 μm. The strip of material may be applied, for example, by laminating, thus making it possible to achieve complete masking and hence particularly effective deactivation of the second layer of adhesive.

Further, the deactivated bonding region may be formed by applying a powder material to the surface of the second layer of adhesive that points in the carrier layer direction. Powder material used may be, for example, talc, chalk, calcium carbonate, kaolin, etc. The powder material may be applied, for example, by powdering, enabling the achievement of particularly thin application and also enabling deactivation in sub-regions.

It is also possible to deactivate the second layer of adhesive by overcrosslinking by means of irradiating the surface pointing in the carrier layer direction. The surface of the second layer of adhesive is irradiated preferably by means of ultraviolet light, in order to trigger the crosslinking process of the surface of the second layer of adhesive. Through the crosslinking of the surface of the second layer of adhesive it is possible to nullify the bonding activity of the second layer of adhesive in the regions of the irradiation, so that the deactivated bonding region can be formed. With this way of forming the deactivated bonding region, therefore, it is unnecessary to apply an additional material to the second layer of adhesive in order to nullify the bonding activity.

The problem addressed by the invention is further achieved by means of a flat web material wound up into a roll, the flat web material comprising a configured and developed adhesive tape as described above.

Also in accordance with the invention is the use of a configured and developed adhesive tape as described above for an on-the-fly roll changeover.

### BRIEF DESCRIPTION OF THE DRAWINGS

Further measures improving the invention are set out in more detail below in conjunction with the description of a preferred embodiment of the invention, with reference to the figures, in which:

FIG. 1 shows a schematic representation of an adhesive tape according to the invention,

FIG. 2 shows a further schematic representation of the adhesive tape according to the invention, and

FIGS. 3a to 3e show a schematic representation of a flat web material according to the invention during an on-the-fly roll changeover.

### PREFERRED EMBODIMENTS OF THE INVENTION

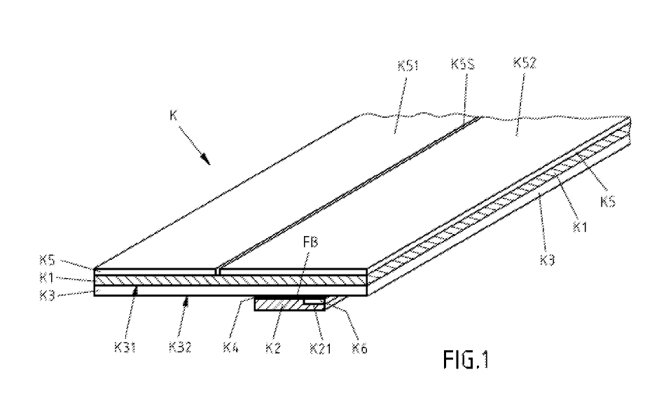

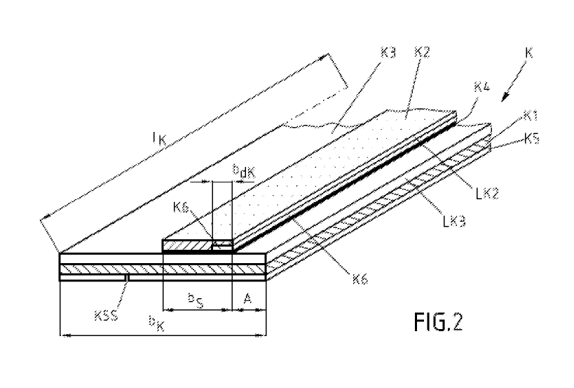

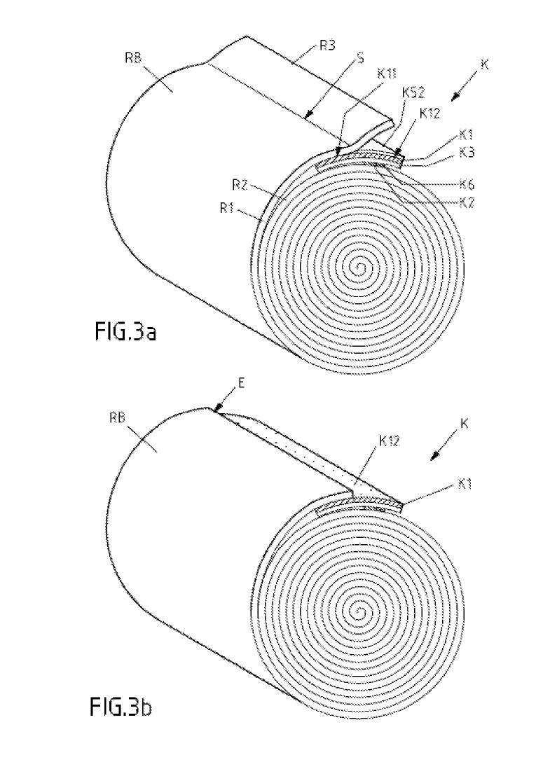

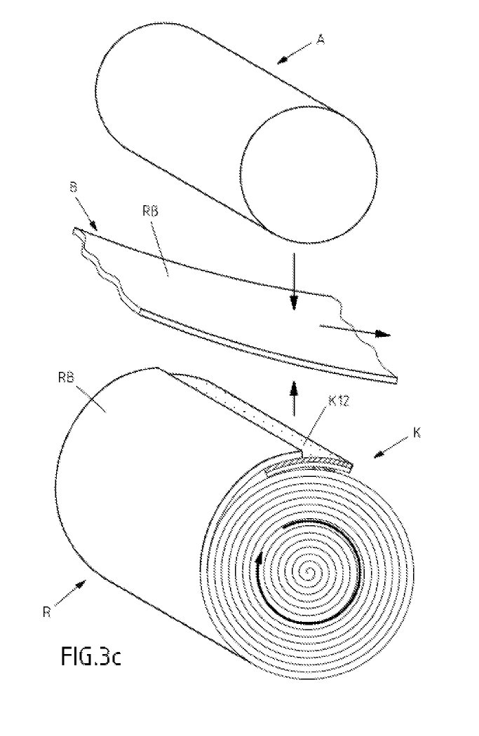

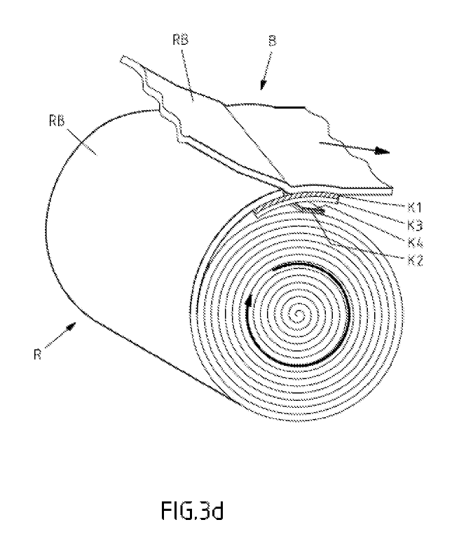

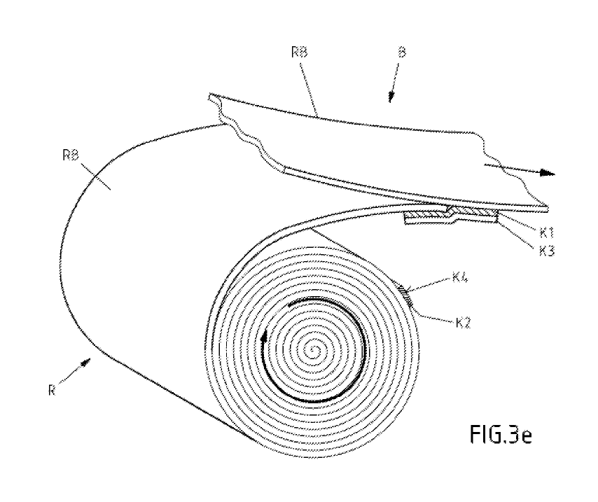

FIGS. 1 and 2 show, schematically, an adhesive tape K which may be disposed on a flat web material RB as shown in FIGS. 3a to 3e, this material RB being wound up into a roll R.

The adhesive tape K comprises a carrier layer K3. The carrier layer K3 has a first surface K31 and a second surface K32 that is opposite the first surface K31.

Disposed on the first surface K31 is a first layer of adhesive K1. The first layer of adhesive K1 may be disposed indirectly or directly on the carrier layer K3. Directly in this context means that the first layer of adhesive K1 bears without interposition on the carrier layer K3. Indirectly means that between the carrier layer K3 and the first layer of adhesive K1 there may be one or more further layers provided, such as, for example, functional layers—for instance, for detection of the adhesive tape K by corresponding detectors, by means of suitable layers, such as, for example, varnish layers, metal layers (e.g. aluminium layers, etc.) or other layers comprising functional additives (such as dyes, metal powders, getters etc.)—, further layers of adhesive, foil layers, layers of textile materials, layers for promoting adhesion between the first surface K31 of the carrier layer K3 and the first layer of adhesive K1, and the like. In the embodiment shown here, the first layer of adhesive K1 is disposed directly on the carrier layer K3, or on the first surface K31 of the carrier layer K3. The first layer of adhesive K1 here is disposed over the full area of the first surface K31 of the carrier layer K3. It is, however, also possible for the first layer of adhesive K1 to be disposed only on certain sections of the first surface K31 of the carrier layer K3 and hence over a partial area thereof, and so two or more first layers of adhesive K1 may be present alongside one another.

In the embodiment shown here, there is a release masking K5 disposed on the first layer of adhesive K1, this release masking K5 having a perforation or a slit K5S in the longitudinal direction I_{K} of the adhesive tape K, so that the release masking K5 can be severed at least in regions. The release masking K5 may, for example, be a siliconized release paper or else a release film.

Disposed on the second surface K32 of the carrier layer K3 is a second layer of adhesive K2, which is disposed indirectly on the carrier layer K3, because of the disposition of a surface coating K4 between the second layer of adhesive K2 and the carrier layer K3. The surface coating K4 and the second layer of adhesive K2 are disposed on an areal region FB of the second surface K32 of the carrier layer K3 that is smaller than the total area of the second surface K32 of the carrier layer K3. It is, however, also possible for the surface coating K4 to mask the entire surface area of the carrier layer K3. By means of the surface coating K4 it is possible to create a predetermined breakage area for the areal splitting of the adhesive tape K, with the predetermined breakage area corresponding to the areal region FB on which the surface coating K4 is disposed together with the second layer of adhesive K2. Here, the areal region FB and hence the predetermined breakage area is smaller than the layer of adhesive K2. Preferably FB=K2−K6. The surface coating K4 is greater than or equal to the area of the second layer of adhesive K2.

Since the splitting of the adhesive tape K takes place in the surface coating K4 or between the surface coating K4 and the carrier layer K3, but not within the carrier layer K3, there is in principle no restriction on the choice of material of the carrier layer K3. The only requirement is that the carrier layer K3 can be provided with a surface coating K4 which either exhibits sufficiently low forces of adhesion to the surface K32 of the carrier layer K3, or sufficiently low internal forces of cohesion, that the adhesion of the second layer of adhesive K2 on this surface coating K4 is higher than at least one of the aforementioned forces.

As carrier layer K3 it is possible in principle to use papers, foils—made of plastics, for example—, nonwovens, multi-layer laminates—e.g. of two or more papers or two or more foil materials or paper(s) and foil(s). Laminates of at least one layer of a customary carrier layer material—such as paper and/or plastic—with a metal foil layer (such as aluminium in particular) may likewise be employed.

As surface coating K4, a layer of a chemical substance, for example a binder, may have been applied to the surface K32 of the carrier layer K3. The chemical substance may be applied, for example, in the form of a solution or a dispersion and subsequently dried, to give a dry layer (for example, continuous film or porous coating) which bears on the surface K32 of the carrier layer K3. Through selection of the mode of application, the chemical substance and the concentration of the solution, suspension or dispersion, it is possible to influence the adhesion of the film of the surface coating K4 to the surface K32 of the carrier layer K3.

It is also possible for the solution, suspension or dispersion for forming the surface coating K4 to penetrate into the surface K32 of the carrier layer K3. This may be of interest in particular for the forms of implementation wherein the predetermined breakage area lies within the surface coating K4 and is split by a cohesive fracture in the splitting process.

As carrier layer K3 it is possible to use a coated paper, or the carrier layer K3 used may be of the kind having a coated paper on one surface thereof.

In order to obtain a closed surface and better printability, it is common for papers—such as coating base papers, for instance—to receive a uniform application of a coating slip (also called coloured coating), by means, for instance, of knife coating, roller coating, brush coating or nozzle coating (air nozzle coating, for example), or, for example, by curtain coating. The resulting surface coating is also referred to as a “coat”, and the treated paper as “coated paper”. Papers may have coating on one or both sides.

The coating colours which can be used are customarily composed of two or more of the following main constituents: water, pigments (generally mineral white pigments or white minerals), dispersants for pigments (generally polyacrylates), binders (in general synthetic acrylate or styrene-butadiene copolymers), starch, thickeners (generally methylcellulose derivatives or acrylate copolymers), additives for regulating the viscosity and the water retention, calendering assistants (e.g. waxes), release agents (polyvinyl alcohol, for example), auxiliaries for reducing the wet abrasion, shading dyes (for example fluorescent whiteners), antifoams, biocides.

The solids fraction in a coating colour is customarily about 65 to 70 wt %, of which almost 90% is pigments. The binder fraction is customarily 10 to 15 wt % (based on the dry matter); via the binder fraction it is possible in particular to influence those properties that are relevant for the splitting process in the predetermined breakage site (such as, for example, the tendency to adhesive or cohesive separation, etc.). All other additives are added customarily at low concentrations (in particular below 1 wt %). The selection of the pigments of papers available commercially is guided by the quality requirements of the coated papers, examples being their whiteness, opacity, smoothness, sheen, pick resistance and printability.

As material for the coating slip it is possible to use a chemical composition in which the main constituent comprises one or more minerals—such as, for example, chalk (calcium carbonate), talc, porcelain earth (kaolin, for example China clay)—, one or more protein derivatives—such as casein, for example—, one or more polysaccharides—such as starch, for example—, one or more plastics particles, or a mixture of two or more representatives of the aforementioned substances. Moreover, it is possible additionally or instead to use speciality pigments, such as satin white (calcium aluminate sulfate) or calcined clays.

As a constituent of the chemical composition for the coating slip, it is possible in particular to select at least in part—preferably as main constituent, in other words not more than 50%, and more preferably exclusively—components which are in lamellar and/or sheet form. This can be realized to particular advantage by selecting suitable minerals. Substances, especially minerals, which are in lamellar or sheet form have a structure such that the interactions between the building blocks is not comparable in all dimensions, but is instead greater within a plane (sheet) than between the planes (definition according to Rompp). The difference in interaction is manifested in different interatomic spacings and results in a usually leaf-like splitability. Known examples of such compounds are graphite, montmorillonite and mica. The slidable layers, which are either planar, as in graphite, or wavy, as in phyllosilicates, can easily be displaced parallel to one another. The selection of lamellar and/or sheetlike constituents of the coating slip may be utilized for particularly effective regulatability of the splitability in the sense of the inventive teaching.

Used with particular advantage are coating slips based on kaolin, especially in leaflet form, and/or based on titanium dioxide, since for these a particularly high compatibility with the adhesives has emerged.

Those papers coated on one or both sides may be used to particularly good effect. Since the interface between paper and coating, or the coating itself, constitutes the predetermined breakage area of the system, it is advantageous to select a paper coated on one side only.

For the carrier material it is possible to employ commercial coated papers whose coating can be split off in the course of the splicing operation at the carrier surfaces provided with a second adhesive.

Alternatively, however, uncoated papers may also be first provided with a coating for use as carrier material for the adhesive tape of the invention, or else a paper already provided with a coating is provided with a further surface coating, in which case the splitting during the splicing operation may take place in particular between the original—first—coating and the further surface coating.

Although the splitting—as observed above—takes place between the first coating and the carrier surface, it may be advantageous to increase the anchorage of the second layer of adhesive and the coating by means of a further treatment of the coated surface, in particular by physical methods such as corona or plasma treatment or by chemical methods such as priming.

Further advantageous chemical substances for the surface coating are those chemical compositions of the kind described as laminating compositions in the specifications EP 1 076 026 A and EP 2 116 581 A, for example. Laminating compositions of these kinds typically comprise a binder and also additives which have a weak release activity and also, as and when necessary, elasticizing qualities. Through the selection of the type and amount of the binder it is possible to exert advantageous influence over the splitting properties (especially the tendency to cohesive or adhesive fracture).

One outstandingly employable composition as described by EP 1 076 026 A comprises not only a binder but also silicone-free additives with a weak release effect and also, as and when necessary, elasticizing qualities. As binders it is possible, for example, to use modified starches, or binders of the kind which have long been in use for wet-bonding adhesive tapes. Release agents used may be, for example, talc, stearyl derivatives such as Ca stearate or dispersions of polymeric release agents, especially of silicone-free and fluorine-free release agents, such as dispersions based on copolymers of stearyl methacrylate or stearyl derivatives of maleic acid with styrene, for example. As elasticizing agents, whose possible addition is optional, water-soluble polyglycols, for example, may serve. In particular, aqueous preparations with 10 to 90 wt % of binder and 10 to 90 wt % of release agent and also up to 60 wt % of elasticizing agent may be used as a composition for producing the surface coating. Preferred for use as binders are starch derivatives, such as anionic potato starch, for example, in fractions of 30 to 70 wt %. Release agents used are preferably talc, Ca stearate and/or copolymers with stearyl groups that exhibit release activity, in fractions of 30 to 80 wt %. For elasticization, polypropylene or polyethylene glycols, especially those which are water-soluble, have proved to be highly suitable, preferably in amounts of between 0 to 15 wt %. Used primarily in this context are the products of higher molecular mass that are solid at room temperature. Further elasticizing agents which can be put to good use in relatively large proportions are gum arabic and polymers with a similar profile of properties. Fillers and/or thickeners may be added to the composition, particularly in a proportion of up to 30 wt %.

A further composition which can be employed outstandingly for generating the surface coating comprises at least one polysaccharide component and a surfactant component. Such compositions are described in EP 2 116 581 A and can also be utilized to good effect for the present invention. A composition used for the surface coating here is a composition of the kind which in addition to a binder, more particularly a polysaccharide component, comprises at least one surfactant component which serves in particular as release agent. The surfactant component may be a single surfactant; it is also possible, however, to use a surfactant component made up of two or more surfactants. As and when necessary, the composition may advantageously comprise further components, including and in particular elasticizing additives (also elasticizing agents hereinafter). In one very preferred procedure, the polysaccharide component is starch, gum arabic or derivatives of the aforesaid compounds. The binder component, furthermore, may also be a stearate, for example, especially magnesium stearate and calcium stearate. The composition of the binder component may also be such that a mixture of starch with one or more other binders is used. Compositions particularly preferred in accordance with the invention have a polysaccharide fraction of up to 98 wt %, more preferably of up to 85 to 95 wt %, better still of 90 to 95 wt %. With particular preference it is possible to use starch derivatives, especially hydroxypropyl ethers based on potato starch. A starch of this kind is available for example from Emslandstarke under the designation Emsol K55. The surfactant content is very preferably 2 to 20, more preferably 5 to 15, ideally 5 to 10 wt %. The fraction data above, both for the polysaccharide component and for the surfactant component, is based on the mixture of surfactant and polysaccharide, especially in each case in the form of the amount based on the solids fraction. Moreover, there is also solvent present, especially water, preferably in fractions of 50% to 80%. A particular procedure possible is to add the solid surfactant to a 20% to 40% strength aqueous solution of the polysaccharide component. As further additives it is possible here as well to make use, for example, of talc, Ca stearate and/or copolymers having stearyl groups that exhibit release activity, in fractions of 30 to 80 wt %. For elastisization, polypropylene glycols or polyethylene glycols, preferably in amounts of between 0 to 15 wt %, have proved to be highly suitable. Used primarily in this case are the products of higher molecular mass that are solid at room temperature. Further elastisizing agents which can be employed to good effect in larger fractions are gum arabic and polymers with a similar profile of properties.

The first layer of adhesive K1 and/or the second layer of adhesive K2 may be configured as self-adhesives. Self-adhesives—also referred to as pressure-sensitive adhesives or PSAs—are considered in particular to encompass those polymeric adhesives which—where appropriate through suitable additization with further components, such as tackifier resins, for example—are durably tacky and permanently adhesive at the application temperature (at room temperature unless otherwise defined) and adhere on contact, in particular immediately, to a multiplicity of surfaces, here in particular to the flat web materials (the adhesives exhibit “tack” [adhesiveness or touch-stickiness]). At just the application temperature, without activation by solvent or by heat, though usually under the influence of a greater or lesser pressure, they are capable of wetting an adherend substrate sufficiently that interactions sufficient for adhesion are able to develop between the adhesive and the substrate. Influencing parameters key to this ability include the pressure and the contact time. The particular qualities of the PSAs derive in particular, among others, from their viscoelastic properties.

The adhesive used for the first layer of adhesive K1 is selected preferably with a high tack (touch-stickiness), whereas for the second layer of adhesive K2 a shear-resistant (self-)adhesive is advantageously used.

As self-adhesives it is possible to employ acrylate-based systems, in the form for example of straight acrylic adhesives (homopolymers and copolymers, each based exclusively on acrylate and/or methacrylate monomers; known as 100% systems), as adhesives based on copolymers of acrylic monomers—acrylates, methacrylates—and non-acrylic monomers, or as adhesives based on blends comprising at least two representatives from the list encompassing straight polyacrylates, copolymers of acrylic monomers and non-acrylic monomers, and also (co)polymers only of non-acrylic monomers. It is possible with advantage to use both water-soluble and water-insoluble acrylates. Also employable with particular advantage are acrylates polymerized in water (waterborne systems).

It is possible, moreover, to use natural and synthetic rubber adhesives, silicone-based adhesives, and also dispersions of the above-described compounds.

Also highly useful are mixtures, possibly of two or more phases, of different types of PSAs, examples being mixtures of rubber-based adhesives (natural rubber and/or synthetic rubber) with acrylate adhesives, or mixtures of natural rubber with synthetic rubber. Mixtures of the various components are also employable, selected from the group of the silicone adhesives, the rubber systems (natural rubber and/or synthetic rubber) and/or the acrylate systems.

It is noted that in principle all basic types of PSAs suitable for such adhesive bonds can be used. There is advantage in using repulpable adhesives, more particularly adhesives repulpable according to measurement method TAPPI UM 213 (TAPPI Useful Methods 213, issued 2012), these being adhesives which on reprocessing of the flat web material, more particularly of paper, can be incorporated largely or completely into the pulp, in other words into the paper or fibre slurry in suspension or solution in water.

The second layer of adhesive K2 is applied in the form of a stripe, with the second layer of adhesive K2 extending parallel to a carrier layer K3 edge region LK3 that extends in the longitudinal direction I_{K} of the adhesive tape K. In this case the second layer of adhesive K2 is disposed at a distance A from the carrier layer K3 edge region LK3 extending in the longitudinal direction I_{K} of the adhesive tape K. The distance A, designed as a recess, can be up to 10 mm in size, preferably between 0.5 to 5 mm, very preferably between 1 to 3 mm in size. More particularly the distance A can be 2 mm.

Through the choice of the width bs of the second layer of adhesive K2 it is possible to adjust the splitting energy, the energy that must be expended in order to split completely the predetermined breakage area, independently from the width of the main carrier K3. This is an advantage relative to those systems in which the predetermined breakage area extends over the full area of the width b_{K} of the adhesive tape K.

To overcome the splitting resistance at the leading edge, an increased, maximum force is needed for the initial splitting of the splitting system (initial splitting force). Furthermore, a force at a lower level is needed for splitting over the entire width of the splittable strip (splitting continuation force). The initial splitting force must be set high enough that the product does not open prematurely as a result of the aerodynamic forces and centrifugal forces which act during the acceleration; on the other hand, the splitting continuation force must be set low enough that the complete splitting-through of the splitting system does not result in web tears. A key quality factor is the constant splitting continuation force of the splittable strip, which is set at a defined level within narrow limits.

In order to improve the splitting-off characteristics of the predetermined breakage area, a deactivated bonding region K6 is formed at a surface K21 of the second layer of adhesive K2 that points in the carrier layer K3 direction. As a result of the deactivated bonding region K6, a tear can be initiated deliberately into the predetermined breakage area. The deactivated bonding region K6 does not have any bonding activity, and so in the deactivated bonding region K6 there is no substance-to-substance bond between the second layer of adhesive K2 and of the surface coating K4 and/or the carrier layer K3.

As can be seen in particular in FIG. 2, the deactivated bonding region K6 is disposed adjacently to the edge region LK2 of the second layer of adhesive K2 that extends in the longitudinal direction I_{K} of the adhesive tape K, and so the deactivated bonding region K6 finishes flush with the edge region LK2 of the second layer of adhesive K2.

The deactivated bonding region K6 here extends over the entire length of the second layer of adhesive K2. This deactivated bonding region K6 has the form of a strip. It is also possible, however, for the deactivated bonding region K6 to extend only over a sub-region of the length of the second layer of adhesive K2. It is also possible, moreover, for the deactivated bonding region K6 to have a wave form.

As can be seen in FIG. 2, the deactivated bonding region K6 has a width b_{dK} which is less than half the total width bₛ of the second layer of adhesive K2. In this case the deactivated bonding region K6 may have a width of 0.5 mm≤b_{dK}≤5 mm, preferably of 1 mm≤b_{dK}≤3 mm. With particular preference the deactivated bonding region has a width of 1.5 mm≤b_{dK}≤2.5 mm.

The deactivated bonding region K6 on the surface K21 of the second layer of adhesive K2 may be formed in a variety of ways.

For example, the deactivated bonding region K6 may have been formed by applying an ink or a varnish to the surface K21 of the second layer of adhesive K2 that is pointing in the carrier layer K3 direction. Further, the deactivated bonding region K6 may have been formed by applying a web-like, non-adhesive strip of material to the surface K21 of the second layer K2 of adhesive that is pointing in the carrier layer K3 direction. Further, the deactivated bonding region K6 may have been formed by applying a powder material to the surface K21 of the second layer of adhesive K2 that is pointing in the carrier layer K3 direction. Also possible is for the deactivated bonding region K6 to have been formed by overcrosslinking, by means of irradiation, of the surface K21 of the second layer of adhesive K2 that is pointing in the carrier layer K3 direction. The surface K21 of the second layer of adhesive K2 is irradiated preferably by means of an ultraviolet light, in order to trigger the crosslinking process of the surface K21 of the second layer of adhesive K2. In this embodiment, a layer of adhesive K2 is used which is crosslinkable by means of UV radiation. By virtue of the crosslinking of the surface K21 of the second layer of adhesive K2, it is possible to nullify the bonding activity of the second layer of adhesive K2 in the regions of the irradiation, and so the deactivated bonding region K6 can be formed.

FIGS. 3a to 3e show by way of example an on-the-fly roll changeover, showing more particularly the preparation and implementation of an on-the-fly roll changeover of the flat web material RB by means of the adhesive tape K of the invention. On-the-fly roll changeovers can be implemented in particular such that first of all the new roll R of a flat web material RB is provided, by the flat web section R1 of the new roll R, the section that forms the uppermost turn, being fastened to the flat web section R2 of the new roll R, the section that forms the second turn, using an adhesive tape K of the invention.

The adhesive tape K is first applied to the flat web section R2. Then the first layer of adhesive K1 of the adhesive tape K is only partly exposed. This may be accomplished by the release masking K5 present thereon, as can be seen in FIG. 1, having a slit or a perforation K5S in the longitudinal direction I_{K} of the adhesive tape K, so that the release masking K5 is divided into two parts K51 and K52, or has a predetermined breakage site for producing two parts K51, K52, and then only part of the release masking K51 is removed, with the consequence, as can be seen in FIG. 3a, that an adhesive region K11 and a non-adhesive region K12—since it is masked—extending in each case in the longitudinal direction I_{K} of the adhesive tape K remain, these regions being regions of the first layer of adhesive K1.

This adhesive tape K is then utilized in order to bond the flat web section R1 forming the uppermost turn of a new roll R—the topmost flat web ply—on the flat web section R2 forming the second-from-uppermost turn—the second flat web ply—of the new roll R. The layer of adhesive K2 is first bonded on the flat web section R2. The sub-region of the release masking K51 is opened up and the flat web section R1 is bonded to the free sub-region of the adhesive region K11. As a result, R1 is joined to R2.

The projecting pennant R3 of the flat web section R1 bonded to the first layer of adhesive K1 is then removed to length—cut off, torn off or the like—in the region of the line S shown with dashes to the region K12 of the first layer of adhesive K1 that is masked by the remaining part of the release masking K52, so that the end E of the flat web material RB then formed essentially adjoins the remaining release masking K52 of the first layer of adhesive K1 of the adhesive tape K. The part K52 of the release masking K5 that is still present can then be removed, so that there is an open surface K12 of adhesive that can be utilized for bonding with the outgoing, old flat web B, as shown in FIGS. 3b-3e. It is advantageous here if the surface of adhesive K12, viewed in the running direction of the flat web material RB, is at least as wide as the adhesive region K11.

As can be seen in FIG. 3c, the roll R thus prepared is subsequently placed alongside an almost fully unwound, old roll B that requires replacement, and is accelerated to substantially the same peripheral speed as that roll. Thereupon it is pressed against the flat web material RB of the old roll B, with the aid of a pressure-application cylinder A, for example, with the open areal region K12 of the first layer of adhesive K1 of the adhesive tape K bonding to the flat web material RB of the old roll B with the rolls R, B at substantially the same speeds. In this context it is also possible for different materials to be spliced to one another.

At the same time as or immediately after the bonding to the flat web material RB of the old roll B, the adhesive tape K opens in the predetermined breakage area FB, as can be seen in FIG. 3d, so that the flat web material RB of the new roll R can be integrated into the process with the flat web material RB of the old roll B to which it is adhered, as can be seen in FIG. 3e. By this means it is possible to ensure a continuous process sequence in the context of an on-the-fly roll changeover.

The split-off remnant of the surface coating K4 masks the second layer of adhesive K2 completely after splitting, so that there are no instances of sticking in the further travel through the machinery.

In terms of its implementation, the invention is not confined to the preferred embodiment indicated above. Instead, a number of variants are conceivable, making use of the solutions depicted, even in the case of implementations that are of a fundamentally different kind. All of the features and/or advantages evident from the claims, the description or the drawings, including construction details, spatial arrangements and process steps, may be essential to the invention both individually and in any of a very wide variety of combinations.

1. An adhesive tape (K) for on-the-fly roll changeover of flat web material (RB) wound up into rolls (R, B), having
a carrier layer (K3), which comprises a first surface (K31) and a second surface (K32) opposite the first surface (K31),
a first layer of adhesive (K1), which is disposed indirectly or directly over at least part of the area on the first surface (K31) of the carrier layer (K3),
a second layer of adhesive (K2), which is disposed on at least one areal region (FB) of the second surface (K32) of the carrier layer (K3), and
at least one predetermined breakage area for the areal splitting of the adhesive tape (K),
where the predetermined breakage area is configured such that the at least one areal region (FB) comprises a surface coating (K4), which is disposed between the carrier layer (K3) and the second layer of adhesive (K2),
where the forces of adhesion of the second layer of adhesive (K2) to the surface coating (K4) are greater than the forces of adhesion of the surface coating (K4) to the carrier layer (K3), and/or
where the forces of adhesion of the second layer of adhesive (K2) to the surface coating (K4) are greater than the forces of cohesion within the surface coating (K4),
and
wherein the second layer of adhesive (K2) has a deactivated bonding region (K6) on a surface (K21) pointing in the carrier layer (K3) direction.

2. The adhesive tape (K) according to claim 1, wherein the deactivated bonding region (K6) is disposed adjacently to an edge region (LK2) of the second layer of adhesive (K2), said edge region (LK2) extending in the longitudinal direction (I_{K}) of the adhesive tape (K).

3. The adhesive tape (K1) according to claim 1, wherein the second layer of adhesive (K2) is disposed at a distance from an edge region (LK3) of the carrier layer (K3), said edge region (LK3) extending in the longitudinal direction (I_{K}) of the adhesive tape (K).

4. The adhesive tape (K) according to claim 1, wherein the deactivated bonding region (K6) extends over the entire length or over a sub-region of the length of the second layer of adhesive (K2).

5. The adhesive tape (K) according to claim 1, wherein the deactivated bonding region (K6) has a width b_{dK} which is less than half the total width bₛ of the second layer of adhesive (K2).

6. The adhesive tape (K) according to claim 1, wherein the deactivated bonding region (K6) has a width of 0.5 mm≤b_{dK}≤5 mm.

7. The adhesive tape (K) according to claim 1, wherein the deactivated bonding region (K6) is configured by applying an ink or a varnish to the surface (K21) of the second layer of adhesive (K2) that points in the carrier layer (K3) direction.

8. The adhesive tape (K) according to claim 1, wherein the deactivated bonding region (K6) is configured by applying a web-like, non-adhesive strip of material to the surface (K21) of the second layer of adhesive (K2) that points in the carrier layer (K3) direction.

9. The adhesive tape (K) according to claim 1, wherein the deactivated bonding region (K6) is configured by applying a powder material to the surface (K21) of the second layer of adhesive (K2) that points in the carrier layer (K3) direction.

10. The adhesive tape (K) according to claim 1, wherein the deactivated bonding region (K6) is configured by overcrosslinking by irradiating the surface (K21) of the second layer of adhesive (K2) that points in the carrier layer (K3) direction.

11. A flat web material (RB) wound up into a roll (R, B), where the flat web material (RB) comprises an adhesive tape (K) according to claim 1.

12. A method for an on-the-fly roll changeover comprising a step of applying an adhesive tape (K) configured according to claim 1.

13. The adhesive tape (K) according to claim 6, wherein the deactivated bonding region (K6) has a width of 0 1 mm≤b_{dK}≤3 mm.

14. The adhesive tape (K) according to claim 6, wherein the deactivated bonding region (K6) has a width of 1.5 mm≤b_{dK}≤2.5 mm.
